(19) United States
(12) Patent Application Publication
(10) Pub. No.: US 2016/0372157 A1
(43) Pub. Date: Dec. 22, 2016

(54) DISPLAY CONTROL APPARATUS, DISPLAY CONTROL METHOD, AND STORAGE MEDIUM

(71) Applicant: CANON KABUSHIKI KAISHA, Tokyo (JP)

(72) Inventor: Tetsuhiro Funagi, Tokyo (JP)

(21) Appl. No.: 15/179,776

(22) Filed: Jun. 10, 2016

(30) Foreign Application Priority Data
Jun. 18, 2015 (JP) 2015-123164

(51) Int. Cl. G11B 27/34; H04N 9/87; H04N 5/247; H04N 9/79

(52) U.S. Cl. CPC G11B 27/34; H04N 9/7904; H04N 9/8715; H04N 5/247

(57) ABSTRACT

A display control apparatus includes an acquisition unit that acquires recording period information about recording periods of images captured by a plurality of imaging apparatuses, a determination unit that determines a designated time, an identification unit that identifies one or more imaging apparatuses recording periods of which include the designated time determined by the determination unit from among the plurality of imaging apparatuses based on the recording period information acquired by the acquisition unit, and a display control unit that displays identification information of the one or more imaging apparatuses identified from among the plurality of imaging apparatuses by the identification unit on a display screen.

### BACKGROUND

### Field

Aspects of the present invention generally relate to a method for displaying a video image captured by an imaging apparatus.

### Description of the Related Art

Conventionally, it has been known that recording periods of a plurality of network cameras are displayed on a user interface (i.e., time-line) that indicates time in a network camera system for displaying video images captured by a plurality of network cameras.

Japanese Unexamined Patent Application (Translation of PCT Application) No. 2007-505523 discusses a display method for displaying recording periods of a plurality of selected network cameras.

However, there is a case where a user may have difficulty in designating a recorded video image that is to be displayed thereon.

For example, in a case where recording periods of an entire network cameras are to be collectively displayed when recorded video images of a huge number of network cameras are stored respectively, visibility thereof will be lowered. On the other hand, if a user specifies some of the network cameras to display recording periods of these network cameras, it may require a lot of effort for the user to designate the network cameras, and there is a risk in which overlook caused by a human error may occur.

### SUMMARY

The present disclosure is directed to a method for easily designating a recorded video image to be displayed.

A display control apparatus includes an acquisition unit configured to acquire recording period information about recording periods of images captured by a plurality of imaging apparatuses, a determination unit configured to determine a specified time, an identification unit configured to identify one or more imaging apparatuses recording periods of which include the specified time determined by the determination unit from among the plurality of imaging apparatuses based on the recording period information acquired by the acquisition unit, and a display control unit configured to display identification information of the one or more imaging apparatuses identified from among the plurality of imaging apparatuses by the identification unit on a display screen.

Further features of aspects of the present invention will become apparent from the following description of exemplary embodiments with reference to the attached drawings.

### BRIEF DESCRIPTION OF THE DRAWINGS

FIG. 1 is a block diagram illustrating an example of a general configuration of a camera system.

FIG. 2 is a block diagram illustrating a configuration example of a network camera.

FIG. 3 is a block diagram illustrating a configuration example of an abnormality detection apparatus.

FIG. 4 is a block diagram illustrating a configuration example of a display apparatus.

FIG. 5 is a block diagram illustrating a configuration example of a recording apparatus.

FIG. 6 is a diagram illustrating an example of a time-line user interface (UI).

FIG. 7 is a flowchart illustrating an operation of the display apparatus.

FIG. 8 is a diagram illustrating an example of a UI of the display apparatus.

FIG. 9 is a block diagram illustrating a hardware configuration example of the display apparatus.

### DESCRIPTION OF THE EMBODIMENTS

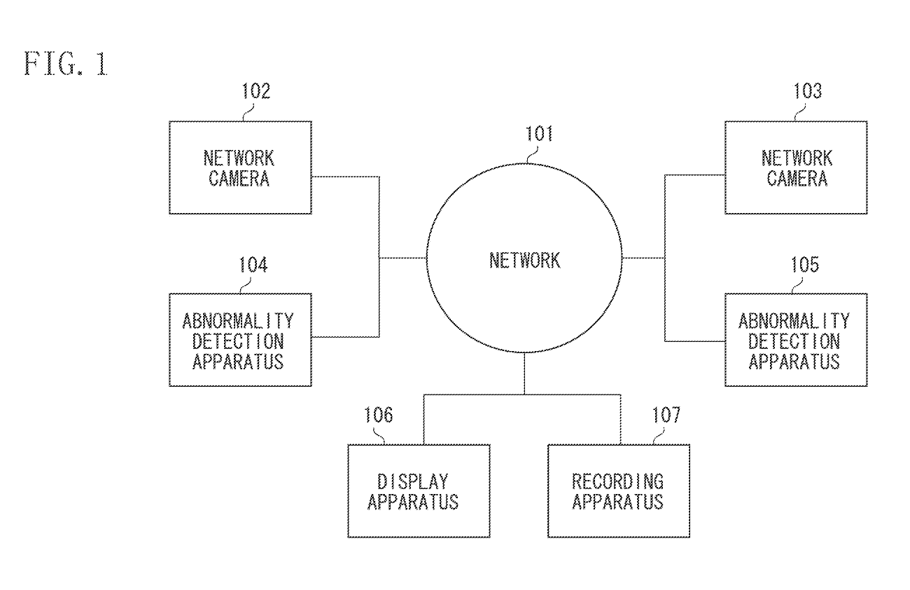

Hereinafter, an exemplary embodiment of the present disclosure will be described in detail with reference to the appended drawings. FIG. 1 is a block diagram illustrating a configuration example of a camera system according to the present exemplary embodiment. As illustrated in FIG. 1, the camera system according to the present exemplary embodiment includes network cameras 102, 103, abnormality detection apparatuses 104, 105, a display apparatus 106, a recording apparatus 107, and a network 101 that connects these apparatuses to each other. In the present exemplary embodiment, description will be mainly given to a case where the network cameras 102 and 103 are provided with a network supporting function. However, a camera (an imaging apparatus) having no network supporting function may transmit a captured video image via another apparatus having the network supporting function. Further, in the present exemplary embodiment, the terms “network camera” and “camera” are used synonymously unless otherwise specified.

Furthermore, the number of cameras, abnormality detection apparatuses, display apparatuses, and recording apparatuses are not limited to the numbers illustrated in the example of FIG. 1, as long as the camera system includes one or more of each of these apparatuses. In addition, a configuration of the apparatuses is not limited to the above example, and the network camera 103 and the abnormality detection apparatus 104 may be integrally configured as one apparatus, or the display apparatus 106 and the recoding apparatus 107 may be locally connected to each other. Further, for example, the display apparatus 106 may have a configuration as separate apparatuses, such as a desktop personal computer (PC) and a monitor. In the above-described example, a main unit of the desktop PC functions as a display control apparatus whereas the monitor functions as a display apparatus.

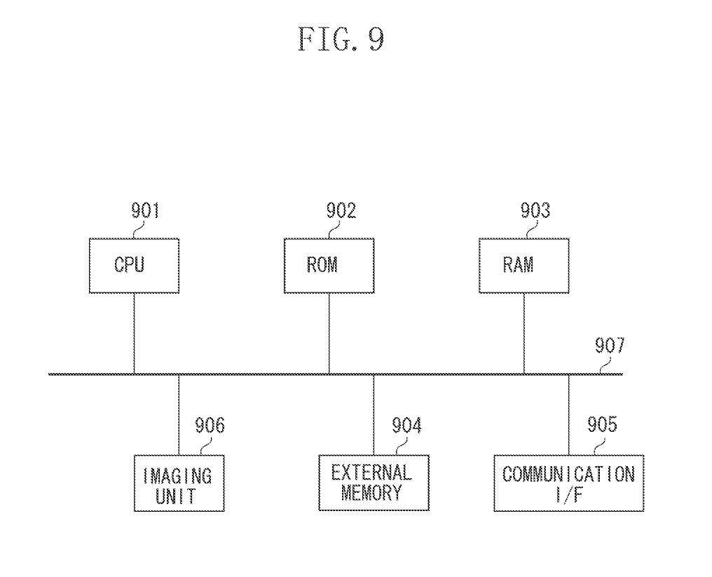

FIG. 9 is a block diagram illustrating an example of a hardware configuration of the display apparatus 106. The display apparatus 106 includes a central processing unit (CPU) 901, a read only memory (ROM) 902, a random access memory (RAM) 903, an external memory 904, a communication interface (I/F) 905, an imaging unit 906, and a system bus 907.

The CPU 901 generally controls operations executed by the display apparatus 106, and controls respective constituent elements (the respective units 902 to 906) via the system bus 907.

The ROM 902 is a non-volatile memory that stores a control program necessary for the CPU 901 to execute processing. In addition, the control program may be stored in the external memory 904 or a detachable storage medium. The RAM 903 functions as a main memory or a work area of the CPU 901. In other words, the CPU 901 loads a program necessary to execute the processing onto the RAM 903 from the ROM 902, and realizes below-described various functional operations of the display apparatus 106 by executing the program.

For example, the external memory 904 stores various kinds of data and information necessary for the CPU 901 to execute processing using the program. Further, for example, various kinds of data and information acquired by the CPU 901 through the processing using the program are stored in the external memory 904. The communication I/F 905 serves as an interface for communicating with an external apparatus (in the present exemplary embodiment, the camera 102 or the recording apparatus 107). For example, the communication I/F 905 may be a local area network (LAN) interface.

The imaging unit 906 includes a solid-state image sensor such as a complementary metal oxide semiconductor (CMOS) sensor or a charge coupled device (CCD) sensor, so as to be capable of capturing a still image and a moving image based on the control of the CPU 901. The system bus 907 communicably connects the CPU 901, the ROM 902, the RAM 903, the external memory 904, the communication I/F 905, and the imaging unit 906.

In addition, the display apparatus 106 does not have to include all of the constituent elements illustrated in FIG. 9. Particularly, the processing according to the present exemplary embodiment can be realized even if the display apparatus 106 does not include the imaging unit 906. Further, hardware configurations of the cameras 102, 103, the abnormality detection apparatuses 104, 105, and the recording apparatus 107 are similar to that of the display apparatus 106.

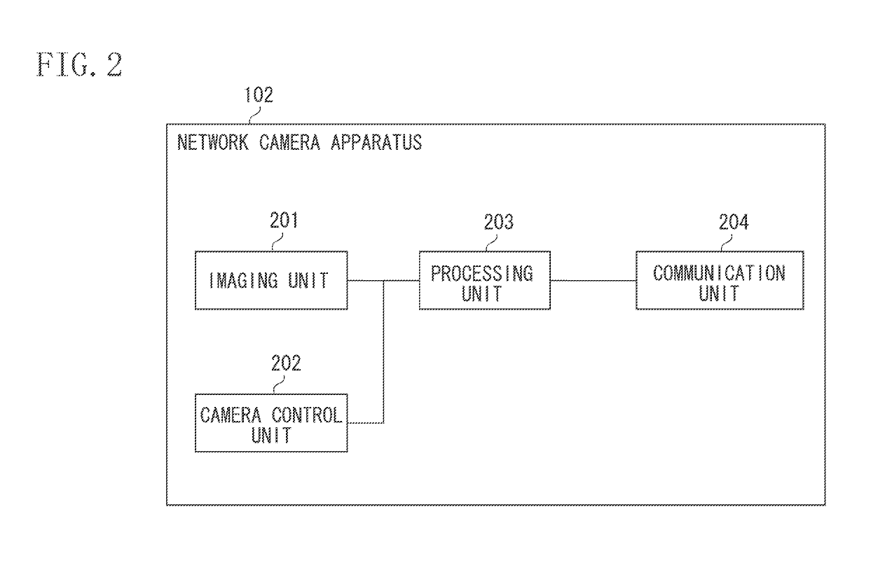

FIG. 2 is a block diagram illustrating an example of a module configuration of the camera 102. The configuration of the camera 103 is similar to that of the camera 102. In the present exemplary embodiment, description will be mainly given to a configuration in which functions of respective modules illustrated in FIG. 2 are executed based on the control of the CPU 901. However, a part of the functions of the modules in FIG. 2 may be realized based on a dedicated processor other than the CPU 901.

The camera 102 includes an imaging unit 201. A camera control unit 202 executes control according to a control command from an external apparatus such as the display apparatus 106 or an operation input through a user interface (UI) included in the camera 102. In other words, according to the control command or the operation input to the UI, the camera control unit 202 executes various kinds of control such as control of a pan head for changing an image-capturing direction, control of imaging condition for setting a zoom, a focus, or an aperture, control of masking processing or time information superimposing processing with respect to a video image, and control of luminance or color tone. However, not all of the above-described control has to be executed thereby.

A processing unit 203 analyzes a control command or a request command from the external apparatus received by a communication unit 204, and executes processing according to the analysis result. For example, when the communication unit 204 receives a control command for controlling the image-capturing direction of the camera 102, the processing unit 203 converts the control command into control data of the camera 102 and transmits the control data to the camera control unit 202. Further, if a request command received by the communication unit 204 is a request for inquiring about the setting condition of the camera 102, the processing unit 203 acquires necessary information from a memory included in the camera 102, converts the information into a response format, and transmits the information to a request source. The communication unit 204 communicates with other apparatuses.

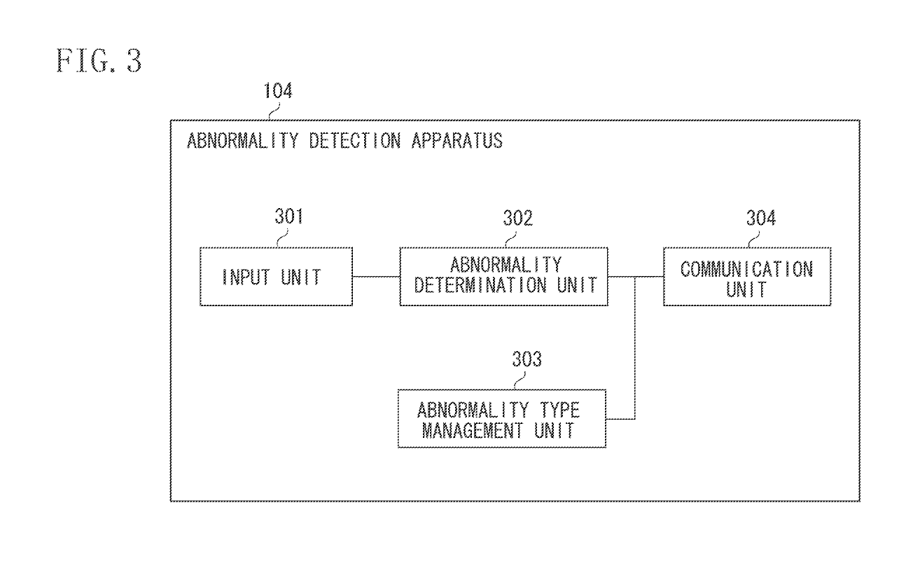

FIG. 3 is a block diagram illustrating an example of a module configuration of the abnormality detection apparatus 104. A configuration of the abnormality detection apparatus 105 is similar to that of the abnormality detection apparatus 104. In the present exemplary embodiment, description will be mainly given to a configuration in which functions of respective modules illustrated in FIG. 3 are executed based on the control of the CPU 901. However, a part of the functions of the modules in FIG. 3 may be realized based on a dedicated processor other than the CPU 901.

An input unit 301 is a unit for detecting an abnormality, and information such as a power supply state of the abnormality detection apparatus 104 or the camera 102, ambient temperature, ambient brightness, sound information, an electromagnetic wave, and a video image captured by the camera 102 can be received thereby. In addition, the abnormality detection apparatus 104 and the camera 102 may be integrally configured as one apparatus.

An abnormality determination unit 302 detects an abnormality (an event) based on an input result received by the input unit 301. When the abnormality determination unit 302 detects the abnormality (or determines that the abnormality has occurred), the abnormality determination unit 302 notifies the display apparatus 106 and the recording apparatus 107 of occurrence of the abnormality and a type of abnormality via the communication unit 304. Identification information of the abnormality detection apparatus 104 is included in the above notification. However, occurrence of the abnormality does not have to be notified to both of the display apparatus 106 and the recording apparatus 107, and the notification may be transmitted to any one of the display apparatus 106 and the recording apparatus 107. Further, a notification destination may be changed according to the type of abnormality detected by the abnormality determination unit 302.

The abnormality determination unit 302 according to the present exemplary embodiment can detect change in the power supply state of the camera 102, rapid change in ambient temperature, rapid change in ambient brightness, generation of sound equal to or greater than a threshold value, and change in a waveform or a wavelength of an ambient electromagnetic wave as the abnormalities (i.e., events). Further, the abnormality determination unit 302 can analyze the video image captured by the camera 102 to detect the abnormality from the analysis result. However, the abnormalities detected by the abnormality determination unit 302 are not limited to the above-described abnormalities, and not all of the above abnormalities have to be detected thereby.

An abnormality type management unit 303 stores and manages a type of abnormality that can be detected through cooperative operations of the input unit 301 and the abnormality determination unit 302. A communication unit 304 communicates with other apparatuses.

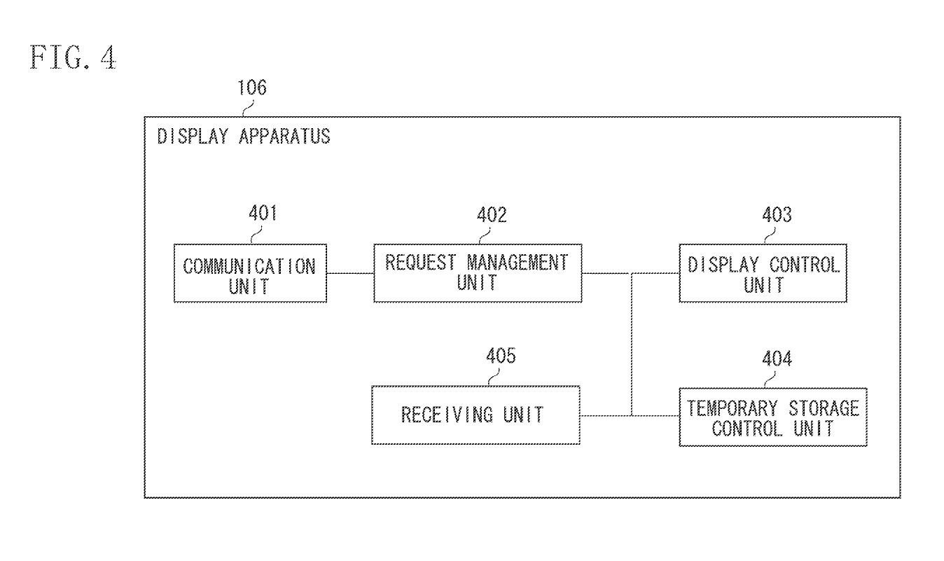

FIG. 4 is a block diagram illustrating an example of a module configuration of the display apparatus 106. In the present exemplary embodiment, description will be mainly given to a configuration in which functions of respective modules illustrated in FIG. 4 are executed based on the control of the CPU 901. However, a part of the functions of the modules in FIG. 4 may be realized based on a dedicated processor other than the CPU 901.

A communication unit 401 communicates with other apparatuses. A request management unit 402 manages transmission of various requests with respect to the recording apparatus 107 and reception of responses from the recording apparatus 107 with respect to the requests. For example, various requests with respect to the recording apparatus 107 may be a request of information about recording periods of respective video images captured by one or a plurality of cameras and an acquisition request of a video image recorded by a specific camera. As a response from the recording apparatus 107, the request management unit 402 receives the information about respective recording periods of one or the plurality of cameras and transmits such information to a temporary storage control unit 404. The temporary storage control unit 404 stores the information about a recording period received from the request management unit 402 in a memory.

Further, as a response from the recording apparatus 107, the request management unit 402 receives a recorded video image of a specific camera and displays that recorded video image on a display screen via a display control unit 403. The display control unit 403 displays a video image received by the display apparatus 106 on a display screen. The temporary storage control unit 404 temporarily stores the information about respective recording periods of one or the plurality of cameras received from the recording apparatus 107 in the memory. In the present exemplary embodiment, although description will be mainly given by taking a recording-start time and a recording-end time as the examples of the information about a recording period, the information is not limited thereto. For example, the information may be a combination of the recording-start time and the recording time, or may be a combination of the recording-end time and the recording time.

A receiving unit 405 receives an instruction from a user. The receiving unit 405 can receive various user instructions input via operation units such as a mouse, a keyboard, and a touch panel. For example, various user instructions may be an instruction for designating image-capturing time of the recorded video image the user would like to display or an instruction for designating a camera the captured video image of which is to be displayed from among a plurality of cameras. In a case where the receiving unit 405 receives an instruction for designating the image-capturing time of the recorded video image the user would like to display, the receiving unit 405 notifies the request management unit 402 of the specified time. Then, according to the notification of the specified time notified from the receiving unit 405, the request management unit 402 transmits a request of information about the recording periods of one or the plurality of cameras to the recording apparatus 107.

On the other hand, in a case where the receiving unit 405 receives an instruction for designating a camera a captured video image of which is to be displayed from among a plurality of cameras, the receiving unit 405 notifies the request management unit 402 of the identification information of that camera. Then, according to the notification of the identification information from the receiving unit 405, the request management unit 402 transmits a request of the recorded video images of one or the plurality of cameras corresponding to the identification information to the recording apparatus 107. In addition, if the notification from the receiving unit 405 is a request for displaying a live video image, the request management unit 402 can transmit a request of a captured video image to the camera 102 instead of the recording apparatus 107.

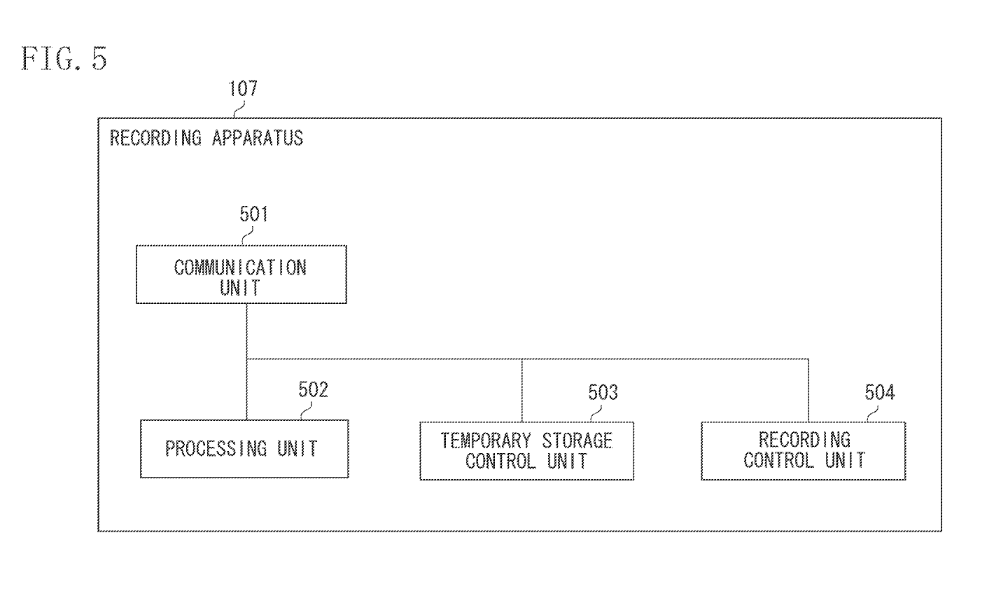

FIG. 5 is a block diagram illustrating an example of a module configuration of the recording apparatus 107. In the present exemplary embodiment, description will be mainly given to a configuration in which functions of respective modules illustrated in FIG. 5 are executed based on the control of the CPU 901. However, a part of the functions of the modules in FIG. 5 may be realized based on a dedicated processor other than the CPU 901.

A communication unit 501 communicates with other apparatuses such as the camera 102 and the display apparatus 106. A processing unit 502 executes the processing requested from the display apparatus 106. A temporary storage control unit 503 temporarily stores a program or data in a memory. A recording control unit 504 stores video images received from a plurality of cameras (the cameras 102 and 103) in the memory as recorded video images. Further, the recording control unit 504 can store information about a recording period of each camera (e.g., information about a recording-start time and a recording-end time) and video image information of a recorded video image (e.g., information about a frame rate and a video image format) in the memory.

A video image analysis program is stored in the memory of the recording apparatus 107. The processing unit 502 executes the video image analysis program to analyze the video image captured by the camera 102, so as to be capable of determining whether to record the captured video image according to the analysis result. When the processing unit 502 determines to start recording, the recording control unit 504 stores the captured video image in the memory while storing trigger information indicating a recording-start trigger in the memory. The recording-start trigger may be detection of a specific event through video image analysis, a notification of abnormality occurrence by the abnormality detection apparatus 104, or a recording-start instruction input by the user of the display apparatus 106. Further, when the processing unit 502 determines to end recording, the recording control unit 504 ends recording of the captured video image and stores trigger information indicating a recording-end trigger in the memory. The recording-end trigger may be a lapse of predetermined time from the specific event detected through the video image analysis, a notification of abnormal ending by the abnormality detection apparatus 104, or a recording-end instruction input by the user of the display apparatus 106.

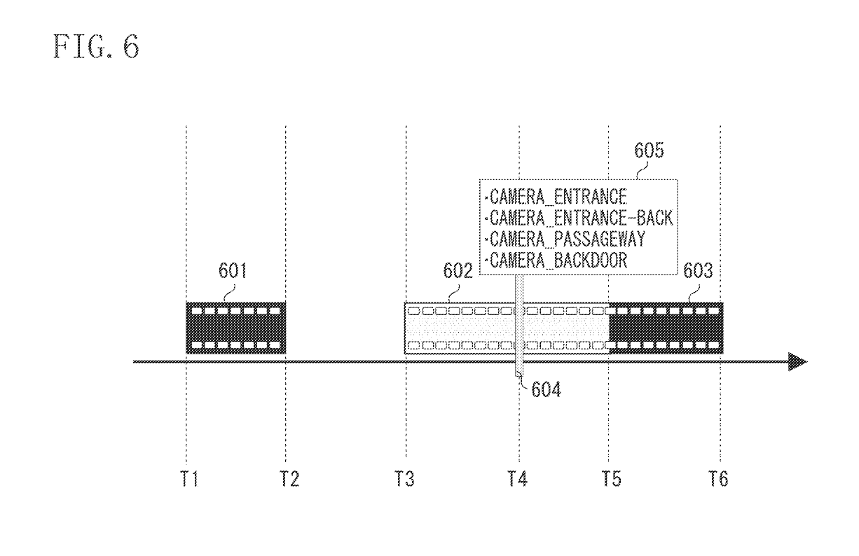

FIG. 6 is a diagram illustrating an example of the UI for displaying a recording period on a time-line in the display apparatus 106. In FIG. 6, of the video image captured by the camera 102 selected by the user from among a plurality of cameras, video images captured in a period from time T1 to T2 and a period from time T5 to T6 are recorded. Further, in FIG. 6, of the video image captured by the camera 103 that is not selected by the user, a video image captured in a period from time T3 to T6 is recorded. As described above, the display apparatus 106 according to the present exemplary embodiment identifiably displays the recording periods of the video images captured by one or the plurality of cameras (i.e., the cameras 102 and 103) on the time-line.

As illustrated in FIG. 6, recording periods 601 and 603 of the camera 102 selected by the user are displayed in a method different from a display method of a recording period 602 of the camera 103 that is not selected by the user. Particularly, in the present exemplary embodiment, the recording periods 601 and 603 are displayed in a color darker than that of the recording period 602. With this configuration, a recording period of the camera selected by the user can be displayed more clearly. However, display methods of the recording periods 601 and 603 and the recording period 602 are not limited to the method using darkness of color, and any display method can be employed as long as the recording periods 601 and 603 can be displayed in a visibility higher than that of the recording period 602.

Further, as illustrated in FIG. 6, a period from T5 to T6 in which the recording period of the camera 102 that is selected by the user and the recording period of the camera 103 that is not selected by the user are overlapping with each other is displayed in the display method of the recording period of the camera 102. Through the above-described display method, the user is less likely to overlook the recording period of the video image captured by the camera 102 selected by the user.

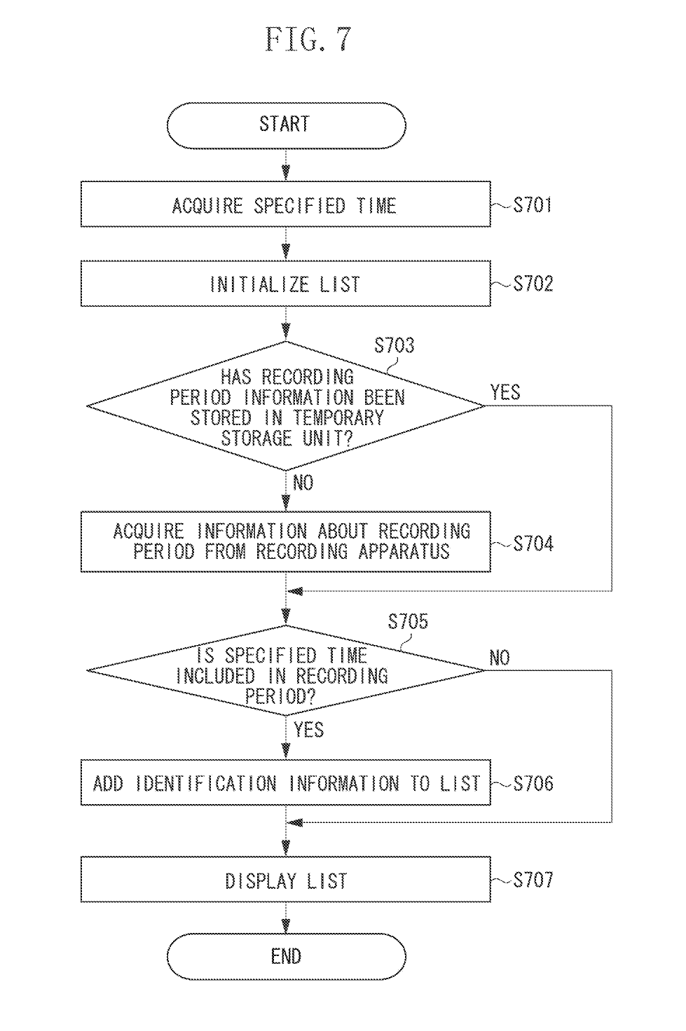

A marker 604 indicates a position where the user has specified on the time-line. In other words, the display control unit 403 of the display apparatus 106 displays a time axis (a time-line) on the display screen. Then, the receiving unit 405 receives a user instruction for designating a position on the time-line. The request management unit 402 identifies one or a plurality of cameras video images of which captured at the time corresponding to the position on the time-line specified by the user are stored in the recording apparatus 107 as the recorded video images. The request management unit 402 can identify one or the plurality of cameras by acquiring the information about the recording periods of the respective cameras from the recording apparatus 107. A list 605 in FIG. 6 illustrates the identification result of one or the plurality of cameras identified by the request management unit 402. Identification information of one or the plurality of cameras is displayed on the list 605. An identification method of one or the plurality of cameras executed by the request management unit 402 will be described below in detail with reference to FIG. 7.

The receiving unit 405 of the display apparatus 106 receives an operation in which the user selects the identification information of a specific camera from the identification information of one or the plurality of cameras displayed on the list 605. For example, when a PC is used as the display apparatus 106, the receiving unit 405 receives an operation for adjusting a mouse cursor to the specific identification information from among the identification information of the plurality of cameras displayed on the list 605. The display control unit 403 updates the recording period displayed on the time-line in such a manner that the recording period of the camera corresponding to the position of the mouse cursor is displayed on the time-line.

In other words, the display control unit 403 executes the following display control in a case where the display control unit 403 receives an operation for designating the identification information of a second imaging apparatus (i.e., the camera 103) from the list 605 after identifiably displaying the recording period of a first imaging apparatus (i.e., the camera 102) on the time-line. The display control unit 403 displays the recording period of the second imaging apparatus instead of the recording period of the first imaging apparatus. Further, in a case where the video image captured by a specific network camera is displayed together with the time-line, the display control unit 403 also changes the captured video image to be displayed thereon according to the camera selected from the list 605. With this configuration, the user can easily check the recording period or the captured video image of the camera of interest.

FIG. 7 is a flowchart illustrating an operation of the display apparatus 106 according to the present exemplary embodiment. Processing in FIG. 7 is realized when the CPU 901 included in the display apparatus 106 reads and executes a necessary program. Further, the processing in FIG. 7 starts when a mode for selecting a recorded video image to be displayed is instructed by the user. However, a timing for starting the processing in FIG. 7 is not limited to the above-described method.

In step S701, the display control unit 403 displays a time-line. Further, in step S701, the receiving unit 405 receives a specification of a position on the time-line. The receiving unit 405 receives the specification of the position on the time-line and notifies the display control unit 403 of time corresponding to that position as a specified time.

In step S702, the display control unit 403 initializes the content of list information illustrated in the list 605 of FIG. 6. Then, the display control unit 403 executes the following processing in steps S703 to S706 with respect to a plurality of cameras in the camera system. In step S703, the display control unit 403 determines whether the information about a recording period of a processing target camera has been acquired from the recording apparatus 107 and stored in the memory.

If it is determined that the information about the recording period of the processing target camera has not been stored in the memory (NO in step S703), the processing proceeds to step S704. In step S704, the request management unit 402 generates a request command of the information about the recording period of the processing target camera, and transmits the request command to the recording apparatus 107. Then, the request management unit 402 acquires the information about the recording period of the processing target camera from the recording apparatus 107. In other words, the request management unit 402 of the display apparatus 106 executes time information acquisition processing for acquiring the information about a recording-start time and a recording-end time of respective recorded video images of a plurality of cameras from the recording apparatus 107 via the network 101. In addition, the request management unit 402 does not have to request the information about an entire recording period of the processing target camera, but may request the information about a recording period within a predetermined range from the time corresponding to the position where the user has specified on the time-line.

In step S705, the display control unit 403 refers to the information about the recording period acquired in step S704 or determined to be stored in the memory in step S703. Then, based on the information about the recording period, the display control unit 403 determines whether the specified time (i.e., the time corresponding to the position where the user has specified on the time-line) exists within the recording period of the video image captured by the processing target camera. In other words, the display control unit 403 determines whether the specified time is included in the recording period of the video image captured by the processing target camera.

If the specified time is included in the recording period of the video image captured by the processing target camera (YES in step S705), the processing proceeds to step S706. In step S706, the display control unit 403 adds the identification information of the processing target camera to the list 605. On the other hand, if the specified time is not included in the recording period of the video image captured by the processing target camera (NO in step S705), the display control unit 403 does not add the identification information of the processing target camera to the list 605. If the processing in steps S703 to S706 has not been completed with respect to the plurality of cameras, the processing returns to step S703, so that the processing in steps S703 to S706 is executed by designating the other camera as a processing target camera. On the other hand, if the processing in steps S703 to S706 has been completed with respect to the plurality of cameras, the display control unit 403 advances the processing to step S707 and displays the list 605. By executing the processing in steps S703 to S706, the display control unit 403 identifies one or the plurality of network cameras whose recording periods of the captured video images include the specified time from among the plurality of network cameras. In other words, based on the information about the recording-start time and the recording-end time of respective recorded video images of the plurality of cameras, the display control unit 403 identifies the identification information of the camera that is to be displayed on the list 605.

When the processing in steps S703 to S706 has been completed with respect to all of the cameras in the camera system, then in step S707, the display control unit 403 displays a list of identification information of the cameras added in step S706. The list 605 of FIG. 6 can be given as an example of the above list. In other words, the display control unit 403 displays a list of identification information of the cameras identified through the processing in steps S703 to S706.

Further, of the identification information of the cameras displayed on the list 605, the display control unit 403 displays a recorded video image of a camera corresponding to the identification information specified by the user on the display screen. In other words, the display control unit 403 displays the identification information of one or the plurality of network cameras identified from among the plurality of network cameras through the processing in steps S703 to S705. Further, the display control unit 403 displays the recorded video image of the network camera corresponding to the identification information specified from one or a plurality of pieces of identification information included in the list on the display screen.

According to the above-described configuration, because the user can easily find out the network camera (the imaging apparatus) that captures the recorded video image corresponding to the time specified by the user from among the plurality of network cameras (the imaging apparatuses), the user can easily designate the recorded video image that is to be displayed thereon.

In addition, the display apparatus 106 can display video images captured by one or the plurality of cameras in addition to displaying the time-line illustrated in FIG. 6 on the display screen. The video images displayed by the display apparatus 106 may be video images directly acquired from one or the plurality of cameras, or may be video images acquired from the recording apparatus 107 as recorded video images.

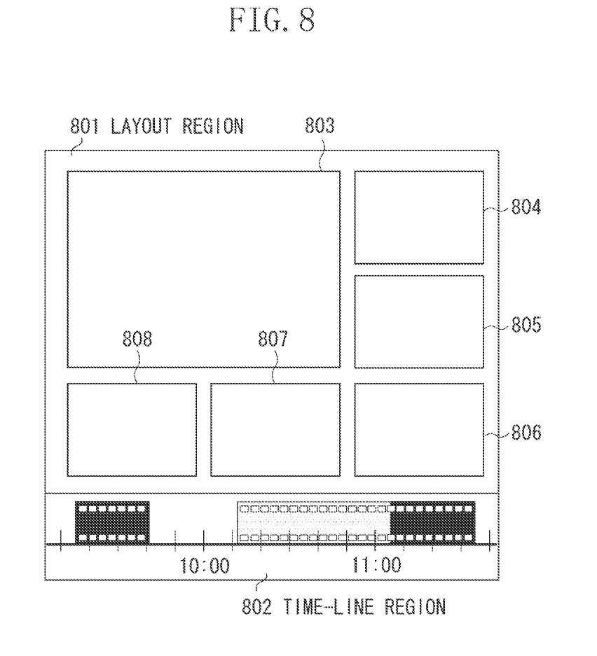

FIG. 8 is a diagram illustrating a configuration example of the display screen of the display apparatus 106. Video images captured by one or the plurality of cameras are displayed on a layout region 801. As illustrated in FIG. 8, the display apparatus 106 can display different video images on a plurality of windows 803 to 808 within the layout region 801. In addition, the user can freely set or change the number of windows and a size or a position of the window.

The time-line described with reference to FIG. 6 is displayed on a time-line region 802. The time-line identifiably shows a recording period of the video image captured by each of the cameras. In FIG. 8, it is assumed that a large number of cameras in addition to the two cameras 102 and 103 are connected to the network. However, for example, video images captured by the single camera 102 at different image-capturing times can be displayed on all of the windows 803 to 808 of FIG. 8.

Further, the display control unit 403 of the display apparatus 106 can execute display control in such a manner that a recording period of the camera that captures the video image displayed on the window specified by the user from among the plurality of windows 803 to 808 is preferentially displayed on the time-line.

Furthermore, when the display control unit 403 displays a list of identification information of one or more cameras recording periods of which include the time specified by the user, the display control unit 403 can change a display method of the identification information depending on whether the video image captured by the camera corresponding to the identification information is displayed on the layout region 801. For example, in a case where the video images captured by the cameras corresponding to the identification information “CAMERA_ENTRANCE” and “CAMERA_ENTRANCE-BACK” are being displayed while the video images captured by the cameras corresponding to the identification information “CAMERA_PASSAGEWAY” and “CAMERA_BACKDOOR” are not displayed thereon, the display control unit 403 displays the list 605 of FIG. 6 in different display methods as follows. For example, the display control unit 403 displays “CAMERA_ENTRANCE” and “CAMERA_ENTRANCE-BACK” in red and displays “CAMERA_PASSAGEWAY” and “CAMERA_BACKDOOR” in black.

However, a method for differentiating the display method is not limited to a method using different display colors, and a method using different color darkness or letter sizes, or a method for displaying identification information with or without blinking may be employed. Further, the identification information may be displayed by being grouped into a group of “CAMERA_ENTRANCE” and “CAMERA_ENTRANCE-BACK” and a group of “CAMERA_PASSAGEWAY” and “CAMERA_BACKDOOR”.

When the identification information of the camera is specified by the user from the list 605 displayed as above, the request management unit 402 acquires the recorded video image of the camera corresponding to the specified identification information from the recording apparatus 107. Then, the display control unit 403 creates a new window within the layout region 801, and displays the recorded video image acquired by the request management unit 402 on the new window.

In other words, in a case where a list of identification information of one or the plurality of cameras is to be displayed when recorded video images of one or the plurality of cameras is being displayed, the display control unit 403 displays the identification information in different display methods depending on whether such identification information corresponds to the camera that captures the video image displayed thereon. Through the above-described configuration, the user can easily select a desired camera when there is a plurality of cameras recording periods of which include the specified time.

Further, according to the notification from the abnormality detection apparatus 104 or 105 or the notification from the user of the display apparatus 106, the recording apparatus 107 can control start or end of recording. In this case, the display apparatus 106 may execute trigger acquisition processing for acquiring the trigger information indicating a recording-start trigger or a recording-end trigger from the recording apparatus 107 to change the display method of the identification information included in the list 605 according to the acquired trigger information.

For example, when the display control unit 403 displays the list 605, it is assumed that intruder detection is used as the recording-start trigger of the video image captured by the camera corresponding to the identification information “CAMERA_ENTRANCE” or “CAMERA_ENTRANCE-BACK”. Further, it is assumed that motion detection is used as the recording-start trigger of the video image captured by the camera corresponding to the identification information “CAMERA_PASSAGEWAY” or “CAMERA_BACKDOOR”. In this case, the display control unit 403 displays the identification information of the cameras in different display methods as follows. For example, the display control unit 403 displays “CAMERA_ENTRANCE” and “CAMERA_ENTRANCE-BACK” in red, and displays “CAMERA_PASSAGEWAY” and “CAMERA_BACKDOOR” in black. However, a method for differentiating the display method is not limited to a method using different display colors, and a method using different color darkness or letter sizes, or a method for displaying identification information with or without blinking may be employed. Further, the identification information may be displayed by being grouped into a group of “CAMERA_ENTRANCE” and “CAMERA_ENTRANCE-BACK” and a group of “CAMERA_PASSAGEWAY” and “CAMERA_BACKDOOR”. In the above description, although an exemplary embodiment using the recording-start trigger as the trigger information has been described as an example, the exemplary embodiment is not limited thereto, and the recording-end trigger or both of the recording-start and the recording-end triggers may be used as the trigger information.

In other words, the display control unit 403 acquires the trigger information indicating at least any one type of trigger from among the recording-start and the recording-end of the recorded video image. Then, when the display control unit 403 displays a list of identification information of one or the plurality of cameras, the display control unit 403 displays the identification information in different display methods according to the type of trigger indicated by the trigger information. According to the above-described configuration, the user can easily select a desired camera when the user would like to check the video image at the time of occurrence of the specific type of trigger.

The type of information used as a trigger is not limited to the information acquired from the intruder detection or the motion detection executed through the video image processing of the captured video image, and other information of various types can be used as a trigger. For example, other information such as the abnormality detected by the abnormality detection apparatus 104 or 105 (i.e., abnormality detected from change in a power supply state, ambient temperature, ambient brightness, sound information, or a waveform), or the start or the end of recording instructed through the user operation may be used as a trigger.

The recording apparatus 107 stores the trigger information indicating at least any one type of trigger from among the recording-start and the recording-end together with the recorded video image, so as to be capable of providing the trigger information according to the request from the display apparatus 106.

Further, the recording apparatus 107 can store video image information of the recorded video image (e.g., information about a frame rate and a video image format) together with the recorded video image. In this case, the display apparatus 106 may execute information acquisition processing for acquiring the video image information from the recording apparatus 107 to change a display method of the identification information included in the list according to the acquired video image information.

For example, it is assumed that frame rates of the captured video images corresponding to the identification information “CAMERA_ENTRANCE” and “CAMERA_ENTRANCE-BACK” are 30 frames per second (fps) when the display control unit 403 displays the list 605. Further, it is assumed that the recording-start triggers of the captured video images corresponding to the identification information “CAMERA_PASSAGEWAY” and “CAMERA_BACKDOOR” are 15 fps. In this case, the display control unit 403 uses different display methods as follows. For example, the display control unit 403 displays “CAMERA_ENTRANCE” and “CAMERA_ENTRANCE-BACK” in red, and displays “CAMERA_PASSAGEWAY” and “CAMERA_BACKDOOR” in black.

However, a method for differentiating the display method is not limited to a method using different display colors, and a method using different color darkness or letter sizes, or a method for displaying identification information with or without blinking may be employed. Further, the identification information may be displayed by being grouped into a group of “CAMERA_ENTRANCE” and “CAMERA_ENTRANCE-BACK” and a group of “CAMERA_PASSAGEWAY” and “CAMERA_BACKDOOR”. In the above description, although an exemplary embodiment using frame rate information as the video image information has been described as an example, the exemplary embodiment is not limited thereto, and information about a video image format or resolution may be used. Further, in the above-described exemplary embodiment, although a configuration in which the display apparatus 106 acquires the video image information from the recording apparatus 107 has been described as an example, the video image information may be acquired from the cameras 102 and 103, or may be determined by the display apparatus 106 based on the content of the recorded video image.

In other words, the request management unit 402 of the display apparatus 106 acquires video image information indicating at least any one of the frame rate and the video image format of the recorded video image. Then, the display control unit 403 of the display apparatus 106 displays the identification information of one or the plurality of cameras in different display methods according to the content of the video image information. Through the above-described configuration, for example, in a case where recording periods of a plurality of cameras that captures the same object conform to each other, the user can easily select the recorded video image appropriate for the display apparatus 106.

According to the configuration described in the present exemplary embodiment, it is possible to easily designate the recorded video image to be displayed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-123164, filed Jun. 18, 2015, which is hereby incorporated by reference herein in its entirety.

What is claimed is:

1. A display control apparatus comprising:
an acquisition unit configured to acquire recording period information about recording periods of images captured by a plurality of imaging apparatuses;
a determination unit configured to determine a designated time;
an identification unit configured to identify one or more imaging apparatuses recording periods of which include the designated time determined by the determination unit from among the plurality of imaging apparatuses based on the recording period information acquired by the acquisition unit; and
a display control unit configured to display identification information of the one or more imaging apparatuses identified from among the plurality of imaging apparatuses by the identification unit on a display screen.

2. The display control apparatus according to claim 1, wherein the determination unit determines the designated time based on a position designated by a user on a time-line displayed by the display control unit.

3. The display control apparatus according to claim 2, wherein the display control unit displays a recording period of an imaging apparatus designated by a user from among the plurality of imaging apparatuses on the time-line.

4. The display control apparatus according to claim 3, wherein, after displaying a recording period of a first imaging apparatus designated by a user from among the plurality of imaging apparatuses on the time-line, the display control unit displays a recording period of a second imaging apparatus on the time-line instead of the recording period of the first imaging apparatus in a case where the second imaging apparatus is designated by a user from among the one or more imaging apparatuses identified by the identification unit.

5. The display control apparatus according to claim 1,
wherein the acquisition unit acquires information about a recording-start time and a recording-end time of images respectively captured by the plurality of imaging apparatuses as the recording period information, and
wherein the identification unit identifies the one or more imaging apparatuses based on the recording-start time and the recording-end time acquired by the acquisition unit.

6. The display control apparatus according to claim 1, wherein, in a case where identification information of the one or more imaging apparatuses identified by the identification unit is to be further displayed while a recorded image is being displayed on the display screen, the display control unit displays one or more pieces of the identification information in different display methods depending on whether the identification information is identification information corresponding to an imaging apparatus that captures a currently-displayed recorded image.

7. The display control apparatus according to claim 1 further comprising a trigger acquisition unit configured to acquire trigger information indicating at least one type of trigger from among a recording-start and a recording-end of the recorded image,
wherein the display control unit displays the identification information of the one or more imaging apparatuses identified by the identification unit in different display methods according to the type of trigger indicated by the trigger information.

8. The display control apparatus according to claim 1 further comprising an information acquisition unit configured to acquire video image information indicating at least any one of a frame rate or a video image format of the recorded image;
wherein the display control unit displays the identification information of the one or more imaging apparatuses identified by the identification unit in different display methods according to at least any one of the frame rate or the video image format indicated by the video image information.

9. A camera system in which a plurality of imaging apparatuses and a display control apparatus are connected to each other, the display control apparatus comprising:
an acquisition unit configured to acquire recording period information about recording periods of images captured by a plurality of imaging apparatuses;
a determination unit configured to determine a designated time;
an identification unit configured to identify one or more imaging apparatuses recording periods of which include the designated time determined by the determination unit from among the plurality of imaging apparatuses based on the recording period information acquired by the acquisition unit; and
a display control unit configured to display identification information of the one or more imaging apparatuses identified from among the plurality of imaging apparatuses by the identification unit on a display screen.

10. A display control method comprising:
acquiring recording period information about recording periods of images captured by a plurality of imaging apparatuses;
determining a designated time;
identifying one or more imaging apparatuses recording periods of which include the designated time from among the plurality of imaging apparatuses based on the acquired recording period information; and
displaying identification information of the one or more imaging apparatuses identified from among the plurality of imaging apparatuses on a display screen.

11. The display control method according to claim 10,
further comprising acquiring information about a recording-start time and a recording-end time of images respectively captured by the plurality of imaging apparatuses as the recording period information, and
further comprising identifying the one or more imaging apparatuses based on the acquired recording-start time and the recording-end time.

12. The display control method according to claim 10, wherein, in a case where identification information of the one or more identified imaging apparatuses is to be further displayed while a recorded image is being displayed on the display screen, one or more pieces of the identification information are displayed in different display methods depending on whether the identification information is identification information corresponding to an imaging apparatus that captures a currently-displayed recorded image.

13. A computer-readable storage medium storing computer executable instructions for causing a computer to execute a display control method comprising:
acquiring recording period information about recording periods of images captured by a plurality of imaging apparatuses;
determining a designated time;
identifying one or more imaging apparatuses recording periods of which include the determined designated time from among the plurality of imaging apparatuses based on the acquired recording period information; and
displaying identification information of the one or more imaging apparatuses identified from among the plurality of imaging apparatuses on a display screen.
